(19) United States
(12) Patent Application Publication
(10) Pub. No.: US 2024/0419401 A1
(43) Pub. Date: Dec. 19, 2024

(54) ARTIFICIAL INTELLIGENCE ACCELERATOR USING MANTISSA QUANTIZATION SCHEME

(71) Applicant: INTERNATIONAL BUSINESS MACHINES CORPORATION, Armonk, NY (US)

(72) Inventors: Derrick LIU, White Plains, NY (US); Ankur AGRAWAL, Chappaqua, NY (US); Chi-Chun LIU, Altamont, NY (US); Shyam RAMJI, LaGrange, NY (US); Naigang WANG, Ossining, NY (US)

(73) Assignee: INTERNATIONAL BUSINESS MACHINES CORPORATION, Armonk, NY (US)

(21) Appl. No.: 18/335,820

(22) Filed: Jun. 15, 2023

(51) Int. Cl. G06F 7/499

(52) U.S. Cl. CPC G06F 7/49915

(57) ABSTRACT

Various embodiments are provided herein for performing a mathematical calculation in a computing environment. A quantization scheme is implemented, allowing at most one (1) non-zero-valued bit in the mantissa of a floating point number.

### BACKGROUND

The present invention relates in general to computing systems, and more particularly, to various embodiments for accelerating multiplication computation for artificial intelligence and deep learning in a computing environment by leveraging a quantization scheme.

### SUMMARY

According to an embodiment of the present invention, a method for accelerating computation in a computing environment, is provided. A quantization scheme is implemented, allowing at most one (1), non-zero-valued bit in the mantissa of a floating point number as will be further described.

An embodiment includes a computer usable program product. The computer usable program product includes a computer-readable storage device, and program instructions stored on the storage device. The computer usable program product includes program instructions for implementing the aforementioned quantization scheme in the computing environment.

An embodiment includes a computer system. The computer system includes a processor, a computer-readable memory, and a computer-readable storage device, and program instructions stored on the storage device for execution by the processor via the memory. In one embodiment, a portion of the computer system is adapted for implementing the aforementioned quantization scheme, such as in a floating point unit (FPU) hardware device integrated into the computer system. The hardware device, and thereby, the computer system, in one embodiment, allows for a streamlined, simplified way to execute various mathematical calculations, resulting in faster processing times, for example.

Thus, in addition to the foregoing exemplary method embodiments, other exemplary system and computer product embodiments are provided.

### BRIEF DESCRIPTION OF THE DRAWINGS

FIG. 1 is a block diagram depicting an exemplary cloud computing node according to an embodiment of the present invention.

FIG. 2 is an illustration of various truncation and/or rounding techniques which, when implemented, serve to implement at least a portion of the quantization scheme according to various embodiments of the present invention.

FIG. 3A is a scatter plot diagram illustrating an exemplary weight distribution of the mantissa of a floating-point number, in a conventional mechanism for performing a mathematical operation in a computing environment.

FIG. 3B is an additional scatter plot diagram illustrating an exemplary weight distribution of a floating-point number, in a conventional mechanism for performing a mathematical operation in a computing environment.

FIG. 3C is an additional scatter plot diagram illustrating an exemplary weight distribution of the exponent portion of a floating-point number as processed through a conventional mechanism for performing a mathematical operation in a computing environment.

FIG. 4A is an additional scatter plot diagram illustrating an exemplary weight distribution of the mantissa of a floating-point number, as processed through a quantization scheme according to an embodiment of the present invention, in comparison to FIG. 3A, previously.

FIG. 4B is an additional scatter plot diagram illustrating an exemplary weight distribution of a floating point number, as processed through a quantization scheme according to an embodiment of the present invention, in comparison to FIG. 3B, previously.

FIG. 4C is an additional scatter plot diagram illustrating an exemplary weight distribution of the exponent portion of a floating-point number as processed through a quantization scheme according to an embodiment of the present invention, in comparison to FIG. 3C, previously.

FIG. 5A is a block diagram of exemplary hardware components for performing, among other aspects, mathematical operations on floating point numbers, according to the conventional state of the art.

FIG. 5B is a block diagram of exemplary hardware components for performing, among other aspects, mathematical operations on floating point numbers implementing, among other aspects, a quantization scheme according to one embodiment of the present invention, in comparison to FIG. 5A, previously.

FIG. 6 is a flow chart diagram illustrating an exemplary method for implementing a quantization scheme in a computing environment, according to one embodiment of the present invention.

FIG. 7 is a flow chart diagram illustrating an additional exemplary method for implementing a quantization scheme in a computing environment, according to an additional embodiment of the present invention.

### DETAILED DESCRIPTION OF THE DRAWINGS

Matrix multiplication, as one of ordinary skill in the art will appreciate, can present a bottleneck in the performance of various computing tasks, such as in Artificial Intelligence (AI) training and inference operations. To address these bottlenecks and improve overall performance, certain modifications may be made to existing hardware configurations to speed up processes such as matrix multiplication for faster computation in these computing systems.

Accordingly, the mechanisms of the illustrated embodiments, following, provide various methods, systems, and computing program products that implement a novel “quantization scheme,” as will be further described, that, for example, “sparsifies” the mantissa, again as will be further detailed. In these embodiments, the need for traditional multiplication operations performing functions like matrix multiplication may be substituted with a novel mechanism that simplifies and streamlines computer hardware design to perform such operations and thereby improves computing performance. In one embodiment, the performance bottleneck that matrix multiplication presents in a conventional computing environment is reduced or eliminated.

To accomplish implementation of such a quantization scheme to perform mathematical operations, a novel hardware design is proposed in accordance with the various embodiments of the present invention. In one embodiment, this hardware design features a modified floating-point-unit (FPU) that, for example, incorporates on-shift operations as opposed to traditional multiplication to achieve the power savings and computational efficiency that the mechanisms of the illustrated embodiments provide.

In one embodiment, the hardware design previously mentioned inclusive of the FPU hardware device is incorporated with a quantization and shift-based multiplier as will be further indicated. In one embodiment, this multiplier device may include a barrel shifter hardware component that one of ordinary skill in the art will appreciate. Other hardware designs, components, techniques, and accompanying software and firmware to implement various exemplary quantization schemes as described herein are contemplated, again as will be appreciated by one of ordinary skill in the art.

It should be noted that one or more calculations may be performed using various mathematical operations or functions that may involve one or more mathematical operations (e.g., solving differential equations or partial differential equations analytically or computationally, using addition, subtraction, division, multiplication, standard deviations, means, averages, percentages, statistical modeling using statistical distributions, by finding minimums, maximums or similar thresholds for combined variables, etc.).

In general, as may be used herein, “optimize” may refer to and/or defined as “maximize,” “minimize,” “best,” or attain one or more specific targets, objectives, goals, or intentions. Optimize may also refer to maximizing a benefit to a user (e.g., maximize a trained machine learning scheduling agent benefit). Optimize may also refer to making the most effective or functional use of a situation, opportunity, or resource.

Additionally, optimizing need not refer to a best solution or result but may refer to a solution or result that “is good enough” for a particular application, for example. In some implementations, an objective is to suggest a “best” combination of operations, schedules, PE's, and/or machine learning models/machine learning pipelines, but there may be a variety of factors that may result in alternate suggestion of a combination of operations, schedules, PE's, and/or machine learning models/machine learning pipelines yielding better results. Herein, the term “optimize” may refer to such results based on minima (or maxima, depending on what parameters are considered in the optimization problem). In an additional aspect, the terms “optimize” and/or “optimizing” may refer to an operation performed in order to achieve an improved result such as reduced execution costs or increased resource utilization, whether or not the optimum result is actually achieved. Similarly, the term “optimize” may refer to a component for performing such an improvement operation, and the term “optimized” may be used to describe the result of such an improvement operation.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), static random access memory (SRAM), dynamic random access memory (DRAM), read-only memory (ROM), nonvolatile memory, erasable programmable read-only memory (EPROM or Flash memory), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as code for acceleration of inflight deployments by inflight deployment module 150. In addition to block 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 150, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

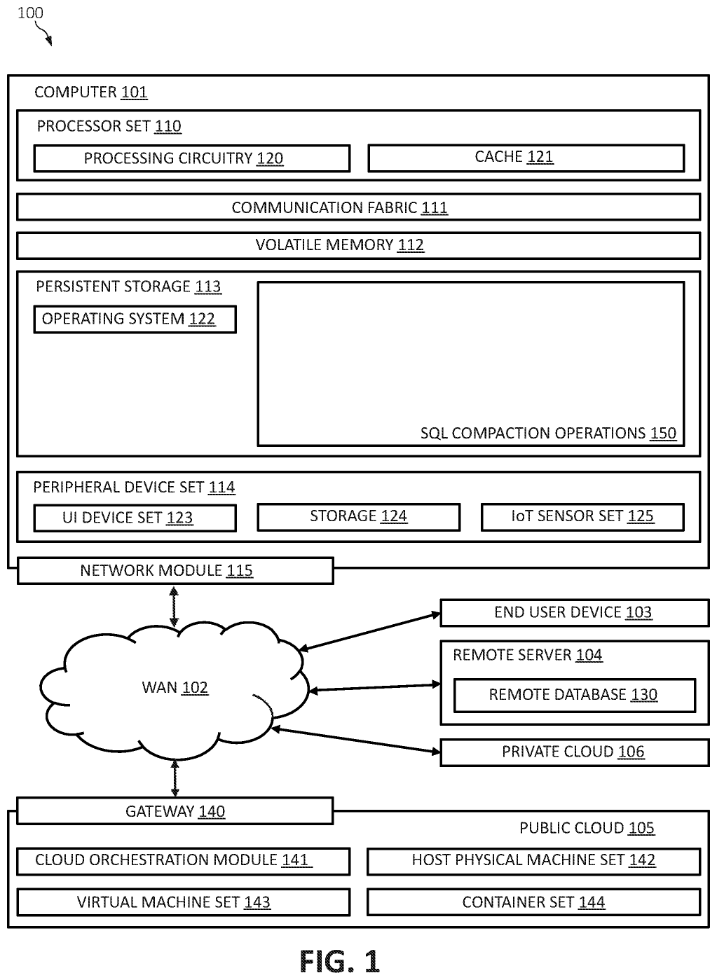

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 150 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

Consider the following runtime Big O notation using two examples of a multiplication operation on two floating-point numbers. In a first example, the number 1337 is multiplied against 1337. The runtime Big O notation for the first example becomes O (n²), where n is the length of the bits, respectively. In a second example, the number 1337 (as used previously) as multiplied against 1000. In this case, the runtime Big O notation for the second example becomes O (n), where the decimal is shifted by the respective number of trailing zeros, in this case, three. In the case of binary notation, the same notion also holds, as one of ordinary skill in the art will appreciate.

Consider further, the IEEE standard floating-point FP16 format. This format, again as one of ordinary skill in the art will appreciate, specifies 5 bits for the so-called “exponent, (bits 10-15)” a single bit for the sign (bit 16), and 10 bits for the “fraction (bits 0-9)”. In this, FP16 format, again consider the multiplication operation previously described.

If instead of the multiplication operation previously described having total possible O (n²) complexity, consider the numerical shift operation described in the second example previously described. In this case, the Big O notation for the shift multiplication operation in FP16 format becomes O(n). Accordingly the format requirement may be represented as (−1)^{signbit}×2^{exponent-15}×1.significantbits₂.

In one embodiment, the bit shift functionality as described may be achieved by what will be described further as “quantizing” the mantissa for one (1) of the values described in the exemplary multiplication operation previously. Exemplary allowed values may include the following: 1.1000000000, or 1.0100000000, or 1.0010000000, or 1.0001000000, and so on, as one of ordinary skill in the art will appreciate.

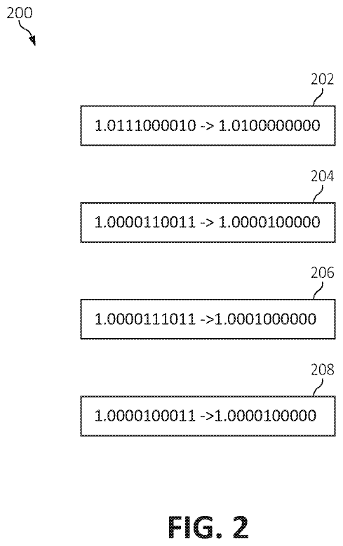

Turning now to FIG. 2, various “quantization” techniques 200 are depicted to perform mathematical operations according to the mechanisms of the present invention, as will be further described. In a first exemplary technique 202, one of the two values to be multiplied through the mathematical operation (1.0111000010) is truncated, so that all remaining digits after the first instance of 1 are designated zero (0) (1.0100000000). In a second exemplary technique 204, one of the two values to be multiplied through the mathematical operation (1.0000110011) is again truncated, so that all the remaining digits after the first instance of 1 are again designated zero (0) (1.0000100000).

In contrast to the truncating methodology described in example techniques 202 and 204, previously, example techniques 206 and 206 implement a “round up” or “round down” methodology. For example in technique 206, one of the two values to be multiplied through the mathematical operation (1.0000111011) is rounded, where the respective trailing bits are again detected and their values are rounded up or rounded down, depending on which value is closest. In technique 206, value (1.0000111011) is rounded up to value (1.0001000000). In technique 208, value (1.0000100000 is rounded down to closest value (1.0000100000) as shown.

Consider the following example of implementing a quantization scheme as described in an artificial intelligence (AI) training process flow. In one embodiment, the mechanisms of the present invention apply the quantization scheme on the mantissa portion of a master weight value to be implemented in the AI training process. Accordingly, due to the simplification of such implementation, a non-trivial speed increase is seen in the computation function of weights as multiplied against other AI variables, such as activations. As a result, the overall processing, throughput, and performance of the AI training process realizes a significant improvement.

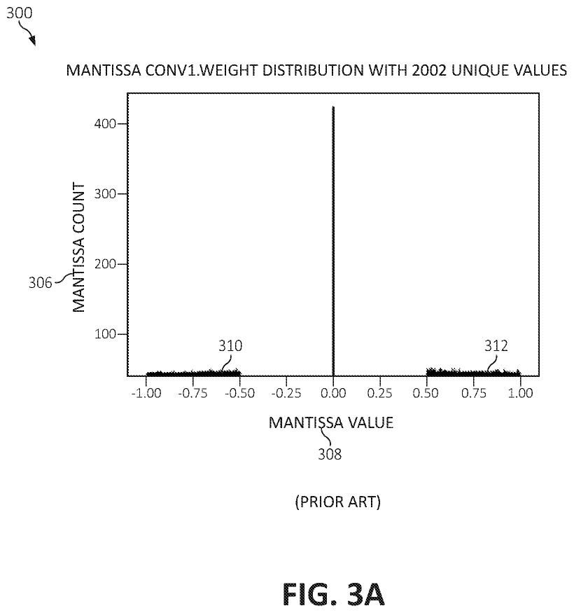

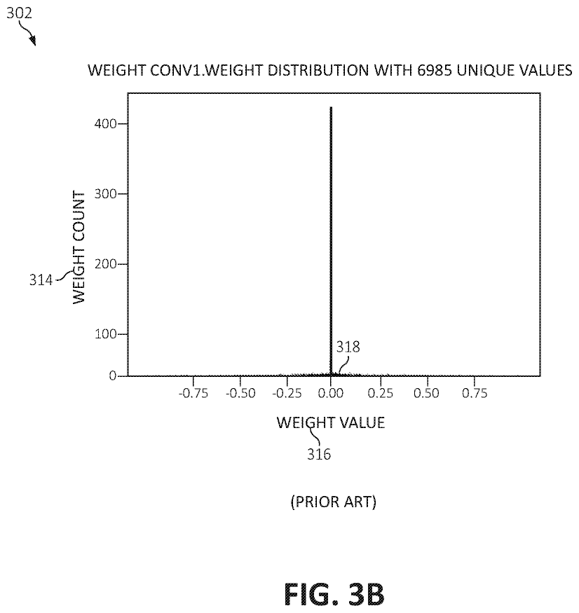

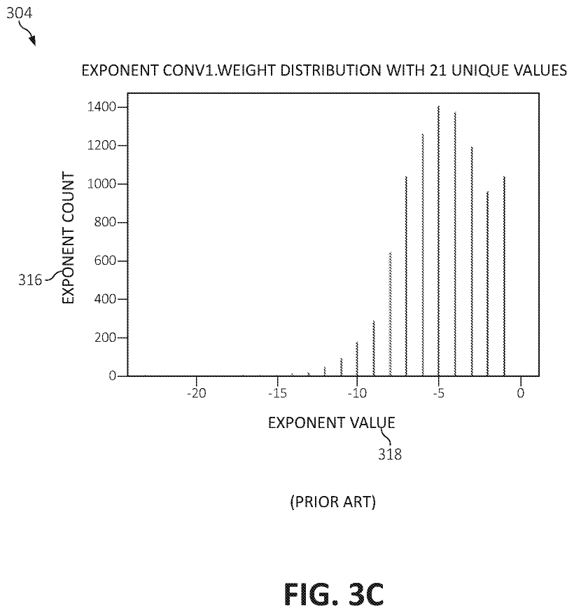

Turning now to FIG. 3A, a scatter plot diagram illustrating an exemplary weight distribution 300 of the mantissa of a floating-point number, in a conventional mechanism (in this case, a normal FP16 scenario) for performing a mathematical operation in a computing environment, is depicted. As shown, the distribution 300 shows mantissa count 306 in the Y-axis ranging from zero (0) to greater than four hundred (400). On the X-axis, the mantissa value 308 shows the value of the mantissa counted in the distribution, ranging from less than negative 1 (−1) to greater than 1 (1).

The multiplication operation sampling run indicates a total count of 2002 unique values that result. Mantissa value 308, reflective of each of the 2002 unique values, is spread evenly as indicated, ranging from negative one (−1) to one (1), with a small number of mantissa counts 306 evenly divided between each range.

FIG. 3B, similarly, is a scatter plot diagram illustrating an exemplary weight distribution 302 of a floating-point number, in a conventional mechanism (here again a normal FP16 scenario) for performing a mathematical operation in a computing environment. The distribution 302 shows weight count 314 along the Y-axis, here again ranging from zero (0) to greater than 400, and weight value 316 as shown along the X-axis.

The multiplication operation sampling run in this case indicates a total count of 6985 values that result. Weight count 314, reflective of the count of the weight values, is spread thinly on each positive and negative range, with a very large concentration 318 of weight value 316 centered at or about zero (0), as one of ordinary skill in the art will appreciate.

FIG. 3C, similarly, is a scatter plot diagram illustrating an exemplary weight distribution 304 of a floating-point number, in a conventional mechanism (here again in a normal FP16 scenario) for performing a mathematical operation in a computing environment. The distribution 304 here shows exponent count 316 along the Y-axis, here ranging from zero (0) to greater than fourteen hundred (1400), and exponent value 318 as shown along the X-axis ranging from less than negative twenty (−20) to greater than zero (0).

The multiplication operation sampling run in this case indicates a total count of 21 unique values that result. Exponent count 316, reflective of each exponent count of the 21 values, is spread in large part in several sections of exponent value 318 as shown between around negative ten (−10) and about zero (0).

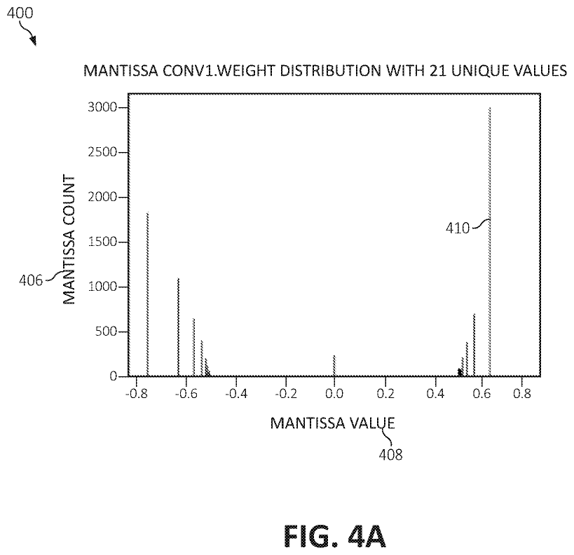

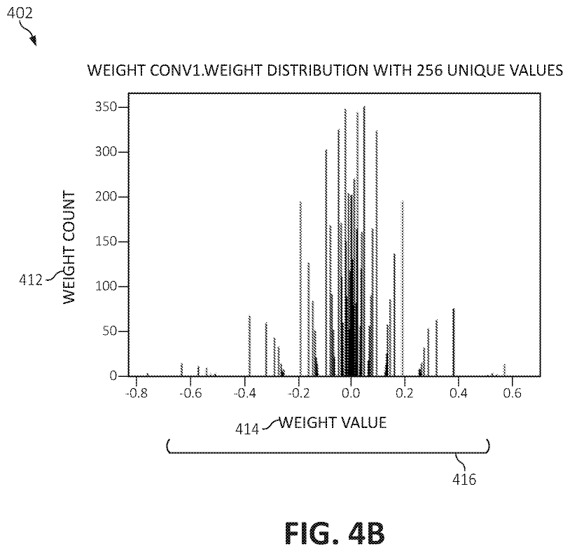

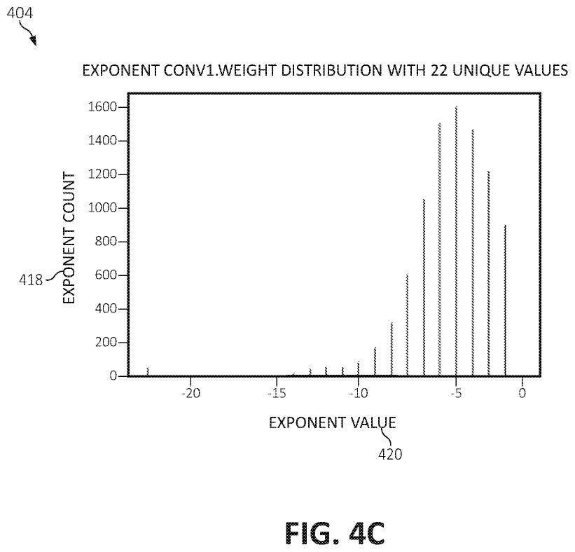

FIG. 4A, following, is an additional scatter plot diagram illustrating an exemplary weight distribution of the mantissa of a floating-point number, as processed through a quantization scheme according to an embodiment of the present invention, in comparison to FIG. 3A, previously. As shown, the distribution 400 of this particular run shows mantissa count 406 in the Y-axis ranging from zero (0) to greater than three thousand (3000). On the X-axis, the mantissa value 408 shows the value of the mantissa counted in the distribution.

Mantissa value 408, representing each of the 21 unique values, is now “quantized” 410 as shown, with values spread throughout the indicated mantissa value 408 range but remaining at a specific indicated mantissa values 408 as shown, rather than thinly spread evenly and thinly throughout, as previously shown in FIG. 3A.

FIG. 4B is an additional scatter plot diagram illustrating an exemplary weight distribution of a floating point number, as processed through a quantization scheme according to an embodiment of the present invention, in comparison to FIG. 3B, previously. The distribution 402 shows weight count 412 along the Y-axis, here in this run ranging from zero (0) to greater than 350, and weight value 414 as shown along the X-axis. Here as shown, the weight distribution 416 is now quantized, with counts of individual weight values distributed uniformly in certain weight values, and concentrated generally between negative zero point two (−0.2) and zero point two (0.2).

FIG. 4C, following, is an additional scatter plot diagram illustrating an exemplary weight distribution of the exponent portion of a floating-point number as processed through a quantization scheme according to an embodiment of the present invention, in comparison to FIG. 3C, previously. The distribution 404 here shows exponent count 418 along the Y-axis, and exponent value 420 as shown along the X-axis.

Thus in both the normal FP16 scenario described in FIGS. 3A-3C and the mechanisms of the present invention, as processed the exponents dominate in both the normal FP16 and the quantization scheme as described.

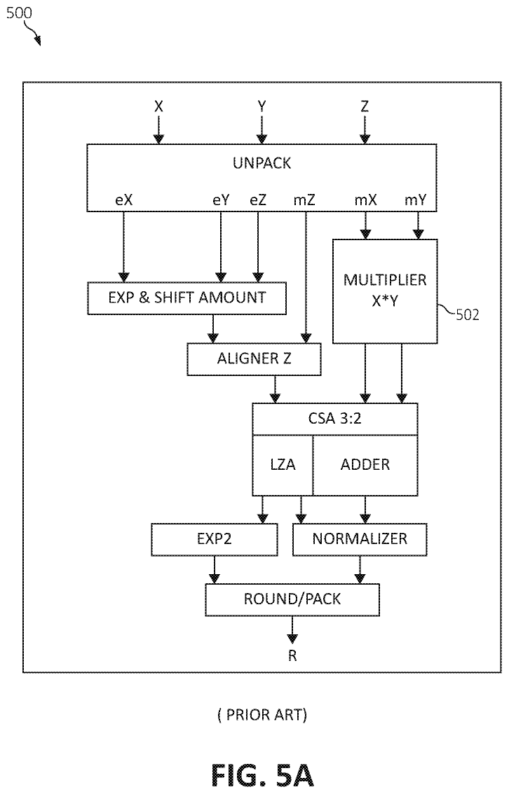

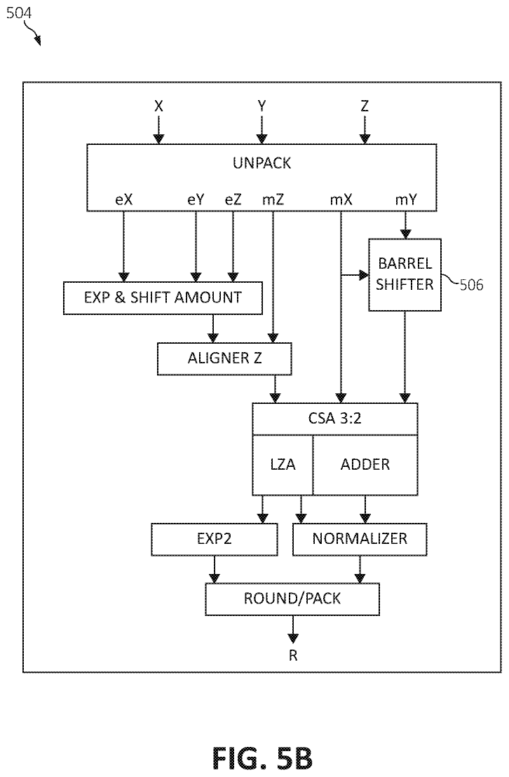

Turning now to FIG. 5A, which is a block diagram of exemplary hardware components for performing, among other aspects, mathematical operations on floating point numbers, according to the conventional state of the art. In one embodiment, the hardware shown in FIG. 5A is a conventional Floating Point Unit (FPU) 500 hardware unit. FPU 500 includes the various components shown that are typical to an FPU 500, and as one of ordinary skill in the art will appreciate. FIG. 5A includes a multiplier 502, which performs conventional tasks like matrix multiplication as previously described according to the state of the art.

FIG. 5B is a block diagram of exemplary hardware components for performing, among other aspects, mathematical operations on floating point numbers implementing, among other aspects, a quantization scheme according to one embodiment of the present invention, in comparison to FIG. 5A, previously.

In one embodiment, FIG. 5B is a modified Floating Point Unit (FPU) 504 device, containing modified hardware for performing floating point operations such as matrix multiplication, but containing novel hardware, firmware, and/or software designs for accomplishing the mathematical operations previously described but in a simplified, less resource-intensive, and time consuming and processing power intensive manner. FIG. 5B, in lieu of multiplier 502, includes barrel shifter device 506, which is adapted to perform the quantization functionality, shifting and other functionality associated with various mechanisms of the present invention. Accordingly, barrel shifter 506, as well as other components of the FPU 504, may be adapted to form various functionality according to the mechanisms of the present invention as previously described.

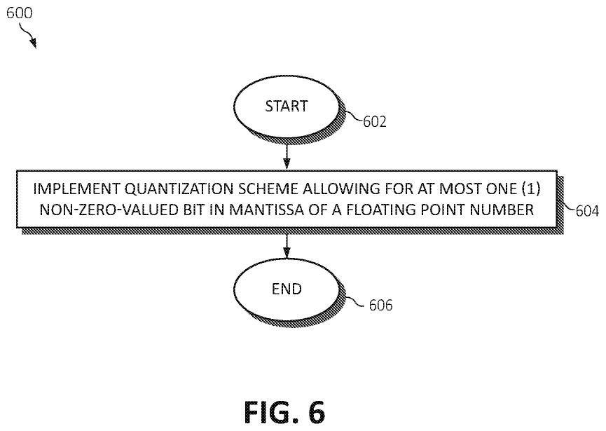

FIG. 6 depicts a flow chart diagram of a method 600 for implementing a quantization scheme along with various embodiments as described in the aforementioned description. Method 600 begins (step 602) by implementing a quantization scheme allowing for at most one (1) non-zero-valued bit in the mantissa of a floating point number (step 604) for one out of two of the numbers being multiplied. Method 600 then ends (step 606).

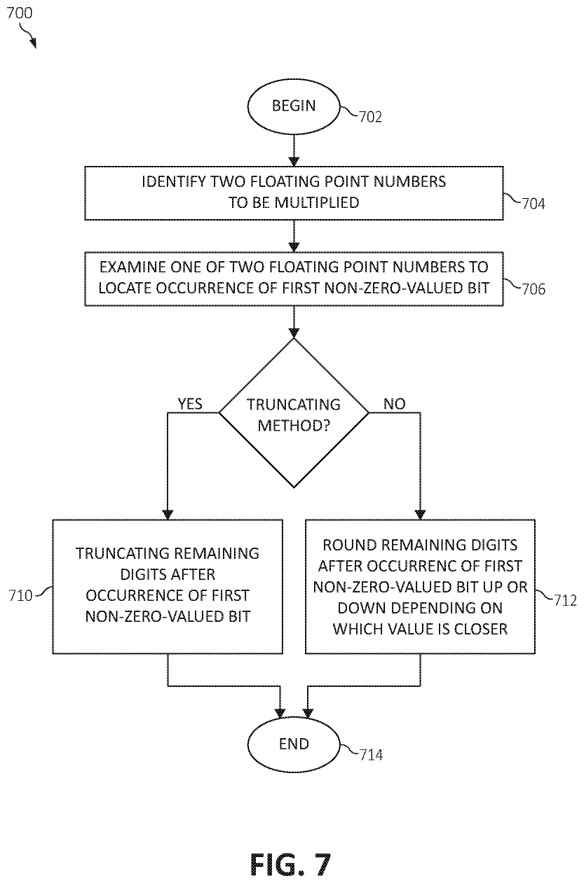

FIG. 7, following, is an additional flow chart diagram of a method 700 for implementing a quantization scheme in an additional embodiment. Method 700 begins (step 702) with the identification of two floating point numbers to be multiplied in step 704, for example, two floating point numbers to be operated upon in a matrix multiplication operation.

As a next step 706, the method 700 examines one of the two floating point numbers to locate the occurrence of the first, non-zero-valued bit. In decision step 708, method 700 queries whether a truncating method is to be used or a rounding method. If a truncating method will be implemented, method 700 then moves to step 710, following, where the remaining digits after the occurrence of the previously identified first non-zero-valued bit are truncated.

Returning to decision step 708, if a rounding method will be implemented, the method 700 then moves to step 712, where the remining digits after the occurrence of the previously identified first non-zero-valued bit are rounded up or down, depending on which value is closer. In either case, following step 710 or step 712, method 700 then ends (step 714).

The present invention may be a system, a method, and/or a computer program product. The computer program product may include a computer readable storage medium (or media) having computer readable program instructions thereon for causing a processor to carry out aspects of the present invention. for implementing multiple thread scenes in a computing environment virtualized metaverse, according to an embodiment of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowcharts and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowcharts and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowcharts and/or block diagram block or blocks.

The flowcharts and block diagrams in the Figures illustrate the architecture, functionality, and operation of possible implementations of systems, methods, and computer program products according to various embodiments of the present invention. In this regard, each block in the flowcharts or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts or carry out combinations of special purpose hardware and computer instructions.

The descriptions of the embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method for accelerating mathematical calculation in a computing environment, by one or more processor devices, comprising:
implementing a quantization scheme allowing at most one (1), non-zero-valued bit in the mantissa of a floating point number.

2. The method of claim 1, wherein the mathematical calculation is a multiplication operation, and implementing a quantization scheme further includes truncating digits remaining after the occurrence of the first non-zero-valued bit of the floating point number, such that the remaining bits in the floating point number are designated as zero bits.

3. The method of claim 1, wherein the mathematical calculation is a multiplication operation, and implementing a quantization scheme further includes rounding digits remaining after the occurrence of the first non-zero-valued bit of the floating point number, such that the remaining bits in the floating point number round up or down depending on which value is closer.

4. The method of claim 1, further including implementing the quantization scheme on a first one of two floating point numbers to undergo a matrix multiplication operation.

5. The method of claim 4, further including enabling the computer hardware required to perform the mathematical operation and implement the quantization scheme in an Artificial Intelligence (AI) core of the computer hardware.

6. The method of claim 1, further including examining the floating point number to locate the occurrence of the first non-zero-valued bit of the floating point number.

7. The method of claim 1, further including implementing the quantization scheme using a modified floating point unit (FPU), and in part, a barrel shifter realized as hardware in the FPU.

8. A system for accelerating a mathematical calculation in a computing environment, comprising:
computer hardware found within the computing environment adapted to implement a quantization scheme, the quantization scheme allowing at most one (1), non-zero-valued bit in the mantissa of a floating point number.

9. The system of claim 8, wherein the mathematical calculation is a multiplication operation, further including computer hardware adapted to, pursuant to implementing the quantization scheme, truncate digits remaining after the occurrence of the first non-zero-valued bit of the floating point number, such that the remaining bits in the floating point number are designated as zero bits.

10. The system of claim 8, wherein the mathematical calculation is a multiplication operation, and further including computer hardware adapted to, pursuant to implementing the quantization scheme, round digits remaining after the occurrence of the first non-zero-valued bit of the floating point number, such that the remaining bits in the floating point number round up or down depending on which value is closer.

11. The system of claim 8, wherein the computer hardware adapted to performing the mathematical calculation and implementing the quantization scheme represents a simplified version of the computer hardware in lieu of a previously adapted portion of the computer hardware performing the mathematical calculation but not implementing the quantization scheme.

12. The system of claim 8, wherein the computer hardware adapted to perform the mathematical operation and implement the quantization scheme is realized in an Artificial Intelligence (AI) core of the computer hardware.

13. The system of claim 8, wherein the computer hardware adapted to perform the mathematical operation and implement the quantization scheme examines the floating point number to locate the occurrence of the first non-zero-valued bit of the floating point number.

14. The system of claim 8, wherein the computer hardware adapted to perform the mathematical operation and implement the quantization scheme is realized in a modified floating point unit (FPU), and in part, in a barrel shifter in the FPU.

15. A computer program product for accelerating a mathematical calculation in a computing environment, the computer program product comprising:
one or more computer readable storage media, and program instructions collectively stored on the one or more computer readable storage media, the program instruction comprising:
program instructions for implementing a quantization scheme allowing at most one (1), non-zero-valued bit in the mantissa of a floating point number.

16. The computer program product of claim 15, wherein the mathematical calculation is a multiplication operation, and further including program instructions for, pursuant to implementing the quantization scheme, truncating digits remaining after the occurrence of the first non-zero-valued bit of the floating point number, such that the remaining bits in the floating point number are designated as zero bits.

17. The computer program product of claim 15, wherein the mathematical calculation is a multiplication operation, and further including program instructions for, pursuant to implementing the quantization scheme, rounding digits remaining after the occurrence of the first non-zero-valued bit of the floating point number, such that the remaining bits in the floating point number round up or down depending on which value is closer.

18. The computer program product of claim 15, further including program instructions for examining the floating point number to locate the occurrence of the first non-zero-valued bit of the floating point number.

19. The computer program product of claim 15, further including program instructions for performing the mathematical operation and executing the quantization scheme in a modified floating point unit (FPU) hardware unit, and in part, as realized in a barrel shifter in the FPU.

20. The computer program product of claim 15, further including program instructions for leveraging simplifications of a hardware design of the computing environment made possible by implementation of the quantization scheme.
